(19) United States
(12) Patent Application Publication
(10) Pub. No.: US 2007/0092147 A1
(43) Pub. Date: Apr. 26, 2007

(54) Multiple-reference motion estimation method and device, coding method and device, computer program products and corresponding storage means

(75) Inventors: Thomas Guionnet, Rennes (FR); Frederic Guillimin, Rennes (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Envivio France, Chantepie (FR)

(21) Appl. No.: 11/542,610

(22) Filed: Oct. 3, 2006

(30) Foreign Application Priority Data
Oct. 3, 2005 (FR) 05/10096

(51) Int. Cl. G06K 9/36

(52) U.S. Cl. 382/238

(57) ABSTRACT

A multiple-reference motion-compensated predictive coding method is provided, which includes a multiple-reference motion estimation step, of the type making it possible to estimate the motion for each current frame included in a video sequence, from at least one initial list of reference frames for said current frame, each initial list LIᵢ including Nᵢ reference frames selected in a predetermined manner, with i>1 and Nᵢ22 2. The multiple-reference motion estimation step includes the following steps for each current frame: for each initial list LIᵢ, obtaining of a corresponding short list LRᵢ by selecting kᵢ reference frame(s) from among the Nᵢ reference frames included in said initial list LIᵢ, with 1<kᵢ<Nᵢ; and estimating motion based on the kᵢ reference image(s) for each short list LRᵢ. A flash frame detection step is performed based on the kᵢ reference frame(s) selected for each short list LRᵢ.

### CROSS-REFERENCE TO RELATED APPLICATION

None.

### FIELD OF THE DISCLOSURE

The disclosure is situated in the field of video compression.

More precisely, the disclosure relates to a multiple-reference motion estimation technique, as well as a multiple-reference motion-compensated predictive video coding technique (the second technique being based on the first one).

The disclosure applies in particular, but not exclusively, to the field of video coder-decoders (codecs) conforming to the MPEG-4 Advanced Video Coding standard (also called AVC, H.264 or MPEG-4 part 10), which include the multiple-reference motion-compensated predictive coding feature.

### BACKGROUND OF THE DISCLOSURE

A distinction is generally made between two types of predictive codecs: conventional motion-compensated ones and multiple-reference motion-compensated ones.

In order to code the current frame Iₜ (in the present text, frame is also called image, these two words being synonymous), a single-reference motion-compensated predictive codec (e.g., of the MPEG-2 type) refers to a preceding frame Iₜ₋ₚ (in the case of a P frame) or else to a preceding frame Iₜ₋ₚ and a following frame Iₜ₊ₛ, simultaneously (in the case of a B frame), with p and s being two positive integers and t a time index integer. The frames to which the current frame refers are called reference frames, or quite simply references (the two expressions are used equally in the remainder of the description). This principle is illustrated by FIGS. 1 and 2. It is important to note that the choice of the reference is imposed by the codec and depends on the type of frames present in the sequence (B or P). Thus, in the case where there are only P frames, p is necessarily equal to 1.

In order to code the current frame Iₜ, a multiple-reference motion-compensated predictive codec (e.g., of the H.264 type) refers to a list of preceding frames L0 (in the case of a P frame) or else to two lists of frames L0 and L1 simultaneously (in the case of a B frame). In the same way as before, the frames contained in the lists L0 and L1 are called reference frames, or quite simply references. This principle is illustrated by FIGS. 3 and 4. Conventionally, each list of references is always built in the same way, regardless of the frame of the video sequence forming the current frame: this list includes a specific number N of consecutive frames that precede (in the case of list L0) or follow (in the case of list L1) the current frame. A certain degree of freedom may be granted in the choice of this number N.

Single-reference motion-compensated predictive coding (conventional) is performing in terms of complexity but limited in terms of compression.

In contrast, multiple-reference motion-compensated predictive coding is more compression efficient but its complexity may be unacceptable. As a matter of fact, it requires a motion estimation step for each of the references, which involves more calculations and memory accesses. This complexity may become unacceptable in the case of real-time applications or with limited-performance machines.

For more details about motion estimation and video coding in general, the following document may be cited: “lain E. G. Richardson “Video Codec Design”, Wiley, 2002”.

For more details about multiple-reference coding, the following document may be cited: “Wiegand, et al. “Multi-Hypothesis Motion-Compensated Video Image Predictor” U.S. Pat. No. 6,807,231, Oct. 19, 2004”.

### SUMMARY

An embodiment of the invention relates to a multiple-reference motion estimation method, of the type making it possible to estimate the motion for each current frame included in a video sequence, from at least one initial list of reference frames for said current frame, each initial list LIᵢ including Nᵢ reference frames selected in a predetermined manner, with i>1 and Nᵢ>2. Said method includes the following steps for each current frame;
for each initial list LIᵢ, obtainment of a corresponding short list LRᵢ by selecting kᵢ reference frame(s) from among the Nᵢ reference frames included in said initial list LIᵢ, with 1<kᵢ<Nᵢ:
motion estimation based on the kᵢ reference image(s) for each short list LRᵢ.

Thus, this embodiment of the invention rests on a completely novel and inventive approach to multiple-reference motion estimation.

Therefore, the basic principle of this embodiment invention includes limiting the number of references actually used during the motion estimation for each current frame. In other words, each initial list of references is replaced by a short list of references. By selecting an inexpensive implementation, in terms of complexity, of the step for obtaining a short list from an initial list (also hereinafter called “step for selecting better references”), the complexity of this step can be considered as insignificant in relation to the rest of the motion estimation process. In this case, the complexity of the motion estimation according to an embodiment of the invention is parameterised by the value of the k parameter, according to the capabilities of the hardware used or the application concerned.

It is important to note that, in order to obtain the short lists of references associated with the successive current frames of the same video sequence, an embodiment of the invention does not consist in selecting the temporal ranks of k references in a predetermined manner, from among N possible references, in a manner common to all of the successive current frames. Thus, if the example of a current frame Iₜ of type P is taken, with an initial list of references LI0 including three frames Iₜ₋₁, Iₜ₋₂ and Iₜ₋₃ that precede the current frame N=3, and a short list of references LR0 including two frames k=2, an embodiment of the invention does not consist in systematically selecting the frames Iₜ₋₁, and Iₜ₋₂ (temporal ranks −1 and −2). If the aforesaid example is taken up again, using an embodiment of the invention, the short list includes two references whose temporal ranks are variable from one current frame to the other, based on the result of the selection step. The short list of references includes, for example, the references Iₜ₋₁ and Iₜ₋₂ for the first current frame, the references Iₜ₋₁ and Iₜ₋₃ for the second current frame, the references Iₜ₋₂ and Iₜ₋₃ for the third current frame, etc.

In a first advantageous application (e.g., the case of a P-type current frame), the motion estimation method is of the type that makes it possible to estimate the motion for each current frame included in a video sequence, from a single initial list L of preceding reference frames, which includes the N consecutive frames that precede the current frame in the video sequence, with N>2.

In the case of this first advantageous application, the motion estimation method includes the following steps for each current frame:
obtainment of a short list LR by selecting k reference frame(s) from among the N reference frames included in the initial list LI, with 1<k<N;
motion estimation based on the k reference image(s) from the short list LR.

In a second advantageous application (e.g., the case of a B-type current frame), the motion estimation method is of the type that makes it possible to estimate the motion for each current frame included in a video sequence from:
a first initial list LI₁, of preceding reference frames, which includes the N₁ consecutive frames that precede the current frame in the video sequence, with N₁>2, and

a second initial list LI₂ of following reference frames, which includes the N₂ consecutive frames that follow the current frame in the video sequence, with N₂>2.

In the case of this second advantageous application, the motion estimation method includes the following steps for the current frame:
obtainment of a first short list LR1 by selecting k₁, reference frame(s) from among the N₁ reference frames included in said first initial list LI₁, with 1<k₁<N;
obtainment of a second short list LR2 by selecting k₂ reference frame(s) from among the N₂ reference frames included in said second initial list LI₂, with 1<k₂<N;
motion estimation based on the k₁, reference frame(s) from the first short list LR₁ and on the k₂ reference frame(s) from the second short list LR₂.

Preferably, the step for obtaining a short list LRᵢ includes the following steps:
for each of the Nᵢ reference frames, calculation of a distance between the current frame and said reference frame;
selection of the kᵢ reference frame(s) whose distances from the current frame are the shortest.

The distance between the current frame and said reference frame advantageously includes a first parameter obtained by a measurement of distance between the content of the current frame and the content of the reference frame, or between the content of a short version of the current frame and the content of a short version of the reference frame.

Within the scope an embodiment of the of this invention, numerous types of distance calculations between the contents of the two frames may be anticipated, and particularly but not exclusively the sum of the absolute values of the pixel-to-pixel differences.

Advantageously, the distance between the current frame and said reference frame includes a second parameter proportional to the temporal distance between the current frame and the reference frame.

According to one advantageous characteristic, in the case where two reference frames are the same distance from the current frame, the reference frame that is temporally closest to the current frame is considered as having a shorter distance than the other reference frame.

Another embodiment of the invention also relates to a multiple-reference motion-compensated predictive coding method including a multiple-reference motion estimation step according to an embodiment of the invention.

Thus, the advantages of the motion estimation technique according to an embodiment of the invention are beneficial to the coding method. As indicated above, the complexity of the motion estimation according to an embodiment of the invention is parameterised by the value of the k parameter. In the context of the multiple-reference motion-compensated predictive coding method, a distinction can be made between the two following cases:
if k is equal to 1, the complexity of the motion estimation according to an embodiment of the invention is identical to that of a conventional single-reference coder, but with potentially improved compression efficiency;
if k is greater than 1, the complexity of the motion estimation according to an embodiment of the invention is higher than that of a conventional single-reference coder, but lower than that of a multiple-reference coder, with substantially equal compression efficiency.

Advantageously, the coding method further includes a flash frame detection method based on the kᵢ reference frame(s) selected from each short list LRᵢ.

In other words, the motion estimation according to an embodiment of the invention further enables detection of flashes with no additional cost in terms of complexity. This information is useful for improving the quality of a coded video.

Advantageously, the flash detection step includes the following steps for each short list LRᵢ:
determination of the reference frame, also known as the reference point frame, which is temporally closest to the current frame, from among the reference frames contained in the short list LRᵢ;
determination of a list LFᵢ of flash frame(s) possibly being empty and including any reference frame from the initial list LIᵢ that is temporally positioned between the current frame and said reference point frame.

Another embodiment of the invention relates to a computer programme product that can be downloaded from a communication network and/or recorded onto a computer-readable and/or processor-executable medium, said computer product including programme code instructions for executing the steps of the motion estimation method according to an embodiment of the invention, when said programme is executed on a computer.

Another embodiment of the invention relates to a computer programme product that can be downloaded from a communication network and/or recorded onto a computer-readable and/or processor-executable medium, said computer product including programme code instructions for executing the steps of the coding method according to an embodiment of the invention, when said programme is executed on a computer.

Another embodiment of the invention relates to a storage means that may be completely or partially removable, computer-readable, and that stores a set of instructions that can be executed by said computer in order to implement the motion estimation method according to an embodiment of the invention.

Another embodiment of the invention relates to a storage means that may be completely or partially removable, computer-readable, and that stores a set of instructions that can be executed by said computer in order to implement the coding method according to an embodiment of the invention.

Another embodiment of the invention concerns multiple-reference motion estimation device of the type that makes it possible to estimate the motion for each current frame included in a video sequence from at least one initial list of reference frames for said current frame, each initial list LIᵢ including Nᵢ reference frames selected in a predetermined manner, with i>1 and Nᵢ>2. According to an embodiment of the invention, said multiple-reference motion estimation device includes:
means for obtaining a short list LRᵢ corresponding to each initial list LIᵢ, by selecting kᵢ reference frame(s) from among the Nᵢ reference frames included in said initial list LIᵢ, with 1<kᵢ<Nᵢ:
motion estimation means based on the kᵢ reference frame(s) for each short list LRᵢ.

Another embodiment of the invention relates to a multiple-reference motion-compensated predictive coding device of the type including a video encoder. According to an embodiment of the invention, the coding device further includes a multiple-reference motion estimation device according to an embodiment of the invention, said motion estimation device cooperating with said video encoder or being at least partially included in said video encoder.

In one advantageous embodiment, the coding device further includes a flash frame detection device using the kᵢ reference frame(s) selected from each short list LRᵢ, said flash frame detection device cooperating with said video encoder or being at least partially included in said video encoder.

The flash detection device advantageously includes:
means for determining, for each short list LRᵢ, the reference frame, also known as the reference point frame, which is temporally closest to the current frame, from among the reference frames contained in the short list LRᵢ;
means for determining a list LFᵢ of flash frame(s), possibly being empty and including any reference frame from the initial list LIᵢ, which is positioned temporally between the current frame and said reference point frame.

Other characteristics and advantages will become apparent upon reading the following description of a preferred embodiment, given as an illustrative and non-limiting example, and the appended drawings.

### BRIEF DESCRIPTION OF THE DRAWINGS

FIG. 1 illustrates the principle of single-reference motion estimation for a P image, according to the prior art;

FIG. 2 illustrates the principle of single-reference motion estimation for a B image, according to the prior art;

FIG. 3 illustrates the principle of multiple-reference motion estimation for a P image, according to the prior art;

FIG. 4 illustrates the principle of multiple-reference motion estimation for a B image, according to the prior art;

FIG. 5 presents a functional block diagram of a first particular embodiment of a device for multiple-reference motion-compensated predictive coding, including a video encoder and a multiple-reference motion estimation device;

FIG. 6 presents a functional block diagram of a second particular embodiment of a device for multiple-reference motion-compensated predictive coding, including a video encoder, a multiple-reference motion estimation device and a flash detection device;

FIG. 7 shows an example of multiple-reference motion estimation for a P image, according to an embodiment of the invention; and

FIG. 8 shows a video sequence example including a flash on one of the frames.

### DETAILED DESCRIPTION OF ILLUSTRATIVE EMBODIMENTS

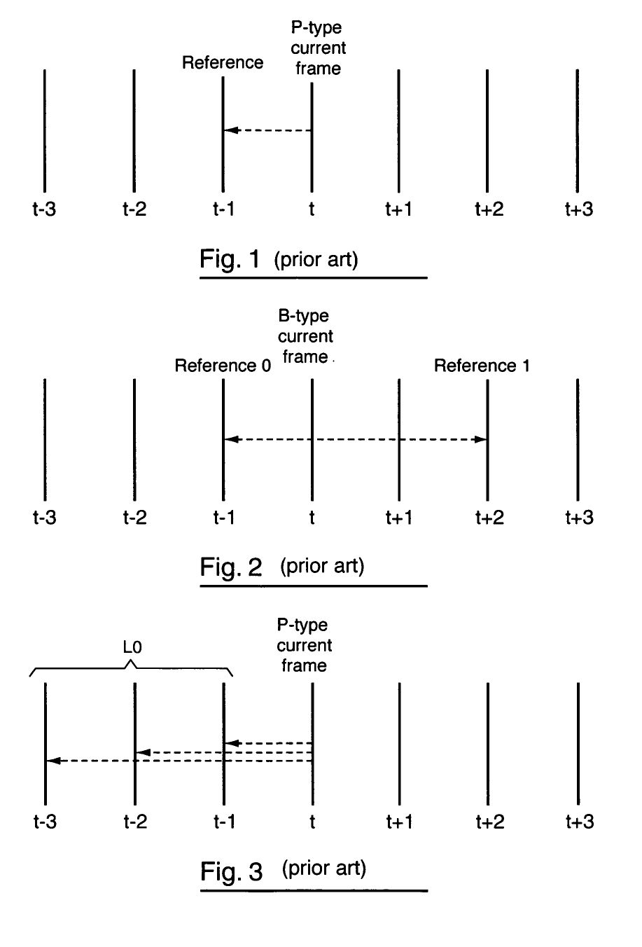

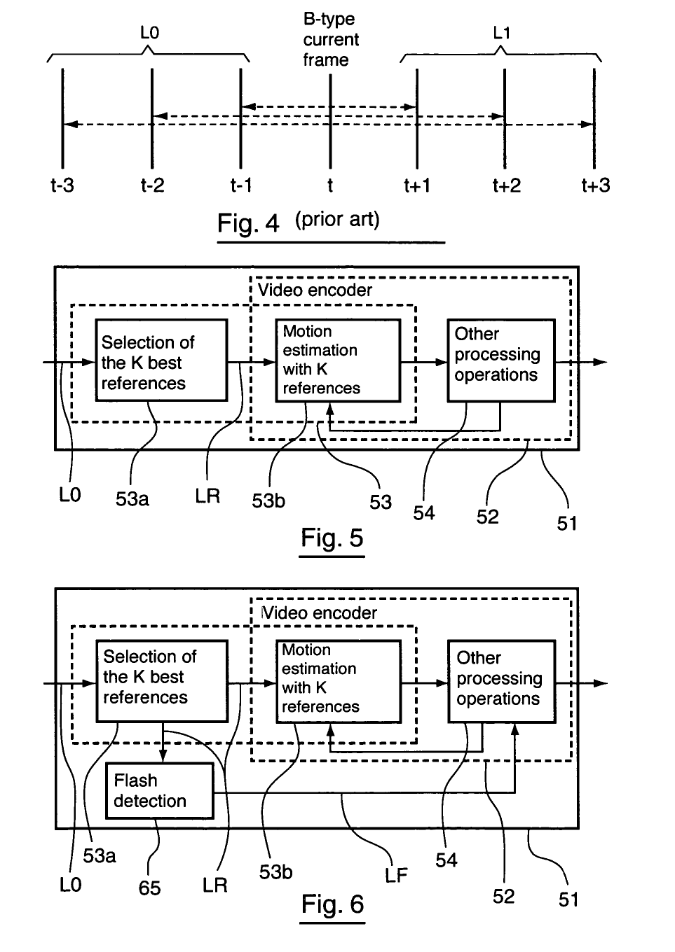

FIGS. 1 to 4 pertain to the prior art. They have already been described above and are therefore not described again.

In all of the figures of this document, identical elements are designated by the same numerical reference.

In the remainder of the description, the process of an embodiment of the invention, in the case of P images, is described for illustrative purposes, without losing comprehensiveness in the case of B images, for which it suffices to repeat the process on the two lists of references.

A first particular embodiment, according to the invention, for multiple-reference motion-compensated predictive coding is now presented in relation to FIG. 5. This coding device 51 includes a real-time video encoder 52 and a multiple-reference motion estimation device 53.

For each frame, the maximum number of references contained in the initial list L0 is equal to N (typically the N consecutive frames that precede the current frame in the video sequence, with N>2).

The multiple-reference motion estimation device 53 includes:
a block 53a for obtaining a short list of references L_{R}, by selecting k best reference(s) from among the N references contained in the initial list LO, with 1<k<N;
a block 53b for motion estimation with k reference(s).

In addition, the encoder 52 includes a block 54 making it possible to perform other processing operations based on the result of the motion estimation provided by the block referenced as 53b.

In this example, the block referenced as 53a is external to the encoder 52, while the block referenced as 53b is included in the encoder 52. In one alternative, the two blocks referenced as 53a and 53b are external to the encoder 52. In another alternative, the two blocks referenced as 53a and 53b are internal to the encoder 52. The block or blocks external to the encoder is (are), for example, included in a pre-analysis module (not shown).

For each current frame, the process of selecting better references (implemented by the block referenced as 53a) is, for example, as follows:
given a difference measurement D(I₁,I₂) between frames, e.g., such as the sum of the absolute values of the pixel-to-pixel differences between short versions of I₁ and I₂;
given I as the current frame;
given L0={R₁, R₂. . . , R_{N}} as the list of references;
for any nε{1 . . . , N}, the calculation Dₙ=D(I, Rₙ) is made;
given L_{R} as the short list of references whose k indices, with 1<k<N, are such that for any n belonging to L_{R} and for any m not belonging to L_{R}: Dₙ<Dₘ. In other words, L_{R} is a short list containing the k references least different from the current frame.

For each current frame, the short list L_{R} is the result of the process of selecting the best references. This short list is sent to the motion estimation block 53b, which then only uses the k references thus designated.

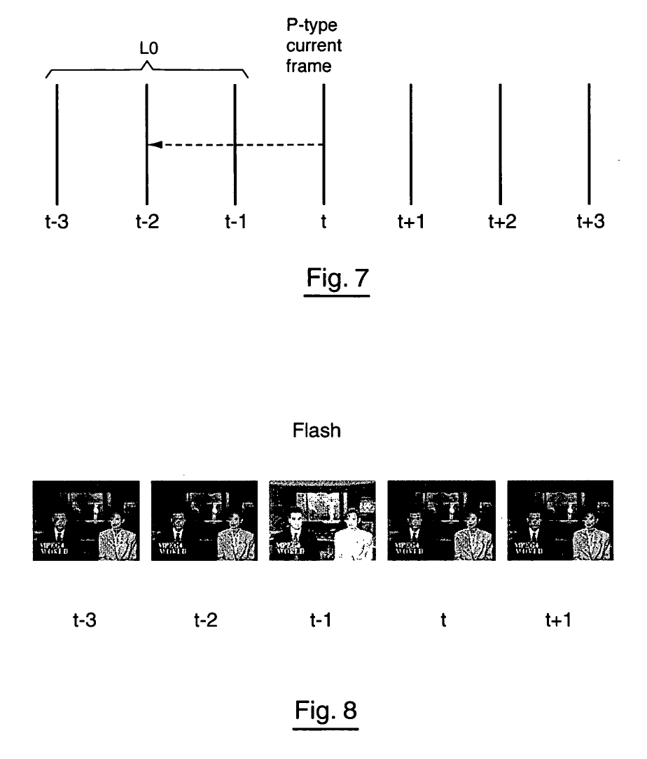

FIG. 7 shows an example of motion estimation for N=3 and k=1. The current frame is the frame Iₜ. The list L0 contains the frames Iₜ₋₁, Iₜ₋₂ and Iₜ₋₃. For the difference measurement D selected, D(Iₜ, Iₜ₋₂I<D(Iₜ, Iₜ₋₁) and D(Iₜ, Iₜ₋₂)<D(Iₜ, Iₜ₋₃) is obtained. Thus, L_{R}={Iₜ₋₂}.

Optionally, in the particular case where certain values for D are equal, then the temporal distance from the current frame is taken into account. The references temporally closest to the current frame are considered as having a lower D value. For example, in FIG. 1, the frame Iₜ₋₁ is temporally closer to the frame Iₜ than the frame Iₜ₋₂.

Optionally, the distance between two frames is corrected by the temporal distance. D(Iₜ, Iₜ₋ₙ)=D′(Iₜ, Iₜ₋ₙ)+α.n, with α a constant fixed a priori (e.g., 810) and D′ the sum of the absolute values of the pixel-to-pixel differences between short versions of Iₜ and Iₜ₋ₙ.

These two optional characteristics can be combined or used separately.

A second particular embodiment of a device, according to the invention, for multiple-reference motion-compensated predictive coding is now presented in relation to FIG. 6.

This second embodiment is distinguished from the first only in that the coding device 61 further includes a flash detection device 65.

In a video sequence, a short, temporary event that significantly modifies the content of the video is called a flash (or else a flash frame). For example, a still camera flash triggered during photo acquisition will produce a lighter single image (as illustrated in FIG. 8). The example of an object that passes before a camera may also be cited.

The parts common to the first and second embodiments (real-time video encoder 52 and multiple-reference motion estimation device 53) are not described again.

The result (short list L_{R}) of the k-reference selection block 53a is used to carry out flash detection.

The flash detection result L_{F} is transmitted to the encoder 52 (and more precisely to the block thereof, referenced as 54), which takes this information into account in order to best parameterise its actions. For example, it is possible to degrade the quality of a flash in order to gain speed for the other frames, without thereby decreasing the final visual quality of the video.

Consider the example of FIG. 8, with k=1, N=3 and Iₜ is the current frame. The list L0 contains the frames Iₜ₋₁, Iₜ₋₂, and Iₜ₋₃. It appears natural to think that the best reference will be Iₜ₋₂ or Iₜ₋₃, but in no case Iₜ₋₁, because the latter is very different from Iₜ.

Thus, the process for selecting a better reference (executed in the block referenced as 53a) implicitly provides a means of detecting flashes, by applying the following rule:
given L_{R} as the list of k references least different from the current frame;
given Rₙ as the reference belonging to L_{R} that is temporally closest to the current frame. For example, in FIG. 8, for N=3 and k=2, if L_{R} contains Iₜ₋₃ and Iₜ₋₂, then Rₙ=Iₜ₋₂;
given L_{F} as the list of the frames of L0 positioned temporally between Rₙ and the current frame. The frames of L_{F} are determined to be flashes. If L_{F} is empty, it is because there is no flash.

The flash detection result is transmitted to the encoder, which takes this information into account in order to adjust the quality and type of frames (I, P, B).

It shall be noted that embodiments of the invention are not limited to a purely hardware implementation but that it can also be implemented in the form of a sequence of computer program instructions or in any form combining a hardware portion and a software portion. In the case where an embodiment of the invention is implemented partially or completely in software form, the corresponding sequence of instructions may or may not be stored in a removable storage means (e.g., such as a diskette, a CD-ROM or a DVD-ROM), this storage means being partially or completely readable by a computer or a microprocessor.

An embodiment of the disclosure provides a multiple-reference motion estimation technique having less complexity than that of the prior art referred to above.

An embodiment provides such a motion estimation technique that is easy to implement and inexpensive.

At least one embodiment provides such a motion estimation technique making it possible to use the multiple-reference motion-compensated predictive coding feature while at the same time limiting the operating complexity of the codec and simplifying its memory management.

At least one embodiment provides such a motion estimation technique making it possible to use the multiple-reference motion-compensated predictive coding feature in real-time applications.

At least one embodiment provides such a motion estimation technique whose intermediate results can be used to easily and inexpensively detect flash frames (also called flashes).

At least one embodiment provides such a motion estimation technique whose intermediate results can be used to easily and inexpensively detect transitions.

Although the present disclosure has been described with reference to preferred embodiments, workers skilled in the art will recognize that changes may be made in form and detail without departing from the spirit and scope of the invention.

What is claimed is:

1. A multiple-reference motion-compensated predictive coding method comprising:
a multiple-reference motion estimation step, of the type making it possible to estimate the motion for each current frame included in a video sequence, from at least one initial list of reference frames for said current frame, each initial list LIᵢ including Nᵢ reference frames selected in a predetermined manner, with i>1 and Nᵢ>2, said multiple-reference motion estimation step including the following steps for each current frame:
for each initial list LIᵢ, obtaining of a corresponding short list LRᵢ by selecting kᵢ reference frame(s) from among the Nᵢ reference frames included in said initial list LIᵢ, with 1<kᵢ<Nᵢ;
estimating motion based on the kᵢ reference frame(s) for each short list LRᵢ; and
a flash frame detection step based on the kᵢ reference frame(s) selected for each short list LRᵢ.

2. The coding method of claim 1, wherein the flash detection step includes the following steps for each short list LRᵢ:
determination of the reference frame, also known as the reference point frame, which is temporally closest to the current frame, from among the reference frames contained in the short list LRᵢ;
determination of a list LFᵢ of flash frame(s) possibly being empty and including any reference frame from the initial list LIᵢ that is temporally positioned between the current frame and said reference point frame.

3. Coding method of claim 1, wherein the multiple-reference motion estimation step makes it possible to estimate the motion for each current frame included in a video sequence, from a single initial list L of preceding reference frames, which includes the N consecutive frames that precede the current frame in the video sequence, with N>2, wherein the multiple-reference motion estimation step includes the following steps for each current frame:
obtaining of a short list LR by selecting k reference frame(s) from among the N reference frames included in the initial list LI, with 1<k<N;
estimating motion based on the k reference frame(s) from the short list LR.

4. The coding method of claim 1, wherein the multiple-reference motion estimation step makes it possible to estimate the motion for each current frame included in a video sequence from:
a first initial list LI₁ of preceding reference frames, which includes the N₁ consecutive frames that precede the current frame in the video sequence, with N₁>2, and
a second initial list LI₂ of following reference frames, which includes the N₂ consecutive frames that follow the current frame in the video sequence, with N₂>2,
and wherein the multiple-reference motion estimation step includes the following steps for the current frame:
obtaining a first short list LR1 by selecting k₁, reference frame(s) from among the N₁ reference frames included in said first initial list LI₁, with 1<k₁<N;
obtaining a second short list LR2 by selecting k₂ reference frame(s) from among the N₂ reference frames included in said second initial list LI₂, with 1<k₂<N;
estimating motion based on the k₁ reference frame(s) from the first short list LR₁ and on the k₂ reference frame(s) from the second short list LR₂.

5. The coding method as claimed in claim 1, obtaining a short list LRᵢ includes the following steps:
for each of the Nᵢ reference frames, calculation of a distance between the current frame and said reference frame;
selection of the kᵢ reference frame(s) whose distances from the current frame are the shortest.

6. The coding estimation method of claim 5, wherein the distance between the current frame and said reference frame includes a first parameter obtained by a measurement of distance between the content of the current frame and the content of the reference frame, or between the content of a short version of the current frame and the content of a short version of the reference frame.

7. The coding method of claim 6, wherein the distance between the current frame and said reference frame includes a second parameter proportional to the temporal distance between the current frame and the reference frame.

8. The coding method as claimed in claim 5, wherein, in the case where two reference frames are the same distance from the current frame, the reference frame that is temporally closest to the current frame is considered as having a shorter distance than the other reference frame.

9. A computer program product that can be downloaded from a communication network and/or recorded onto a computer-readable and/or processor-executable medium, wherein the product includes program code instructions for executing the following steps when said program is executed on a computer:
a multiple-reference motion estimation step, of the type making it possible to estimate the motion for each current frame included in a video sequence, from at least one initial list of reference frames for said current frame, each initial list LIᵢ including Nᵢ reference frames selected in a predetermined manner, with i>1 and Nᵢ>2, said multiple-reference motion estimation step including the following steps for each current frame:
for each initial list LIᵢ, obtaining of a corresponding short list LRᵢ by selecting kᵢ reference frame(s) from among the Nᵢ reference frames included in said initial list LIᵢ, with 1<kᵢ<Nᵢ;
estimating motion based on the kᵢ reference frame(s) for each short list LRᵢ; and
a flash frame detection step based on the kᵢ reference frame(s) selected for each short list LRᵢ.

10. A storage device that may be completely or partially removable, computer-readable, and that comprises a set of stored instructions that can be executed by said computer in order to implement the following steps:
a multiple-reference motion estimation step, of the type making it possible to estimate the motion for each current frame included in a video sequence, from at least one initial list of reference frames for said current frame, each initial list LIᵢ including Nᵢ reference frames selected in a predetermined manner, with i>1 and Nᵢ>2, said multiple-reference motion estimation step including the following steps for each current frame:
for each initial list LIᵢ, obtaining of a corresponding short list LRᵢ by selecting kᵢ reference frame(s) from among the Nᵢ reference frames included in said initial list LIᵢ, with 1<kᵢ<Nᵢ;
estimating motion based on the kᵢ reference frame(s) for each short list LRᵢ; and
a flash frame detection step based on the kᵢ reference frame(s) selected for each short list LRᵢ.

11. Multiple-reference motion-compensated predictive coding device comprising:
a video encoder;
a multiple-reference motion estimation device, cooperating with said video encoder or being at least partially included in said video encoder, and of the type that makes it possible to estimate the motion for each current frame included in a video sequence from at least one initial list of reference frames for said current frame, each initial list LIᵢ including Nᵢ reference frames selected in a predetermined manner, with i>1 and Nᵢ>2, said multiple-reference motion estimation device including:
an element adapted to obtain a short list LRᵢ corresponding to each initial list LIᵢ, by selecting kᵢ reference frame(s) from among the Nᵢ reference frames included in said initial list LIᵢ, with 1<kᵢ<Nᵢ;
a motion estimator, which estimates motion based on the kᵢ reference frame(s) for each short list LRᵢ; and
a flash frame detection device using the kᵢ reference frame(s) selected from each short list LRᵢ, said flash frame detection device cooperating with said video encoder or being at least partially included in said video encoder.

12. The coding device of claim 11, wherein the flash detection device includes:
means for determining, for each short list LRᵢ, the reference frame, also known as the reference point frame, which is temporally closest to the current frame, from among the reference frames contained in the short list LRᵢ;
means for determining a list LFᵢ of flash frame(s), possibly being empty and including any reference frame from the initial list LIᵢ, which is positioned temporally between the current frame and said reference point frame.
